(19) United States
(12) Patent Application Publication
(10) Pub. No.: US 2019/0111373 A1
(43) Pub. Date: Apr. 18, 2019

(54) FILTER ASSEMBLY FOR A VACUUM CLEANER

(71) Applicant: Dyson Technology Limited, Wiltshire (GB)

(72) Inventor: Adam Samuel HILLIARD, Bristol (GB)

(73) Assignee: Dyson Technology Limited, Wiltshire (GB)

(21) Appl. No.: 16/157,466

(22) Filed: Oct. 11, 2018

(30) Foreign Application Priority Data
Oct. 16, 2017 (GB) 1716977.2

(51) Int. Cl. B01D 46/42; B01D 46/24; B01D 46/00; A47L 9/12

(52) U.S. Cl. CPC B01D 46/4227; B01D 46/24; B01D 2279/55; A47L 9/12; B01D 46/0002

(57) ABSTRACT

A filter assembly for a vacuum cleaner has a housing, a filter medium disposed in the housing, a recess formed in a surface of the housing, a tab movable between a first position and a second position, and a fixing member movable between a fixing position and a release position. The fixing member is engageable with the vacuum cleaner when in the fixing position to fix the filter assembly to the vacuum cleaner. The fixing member is disengageable from the vacuum cleaner when in the release position such that the filter assembly may be removed from the vacuum cleaner. The tab is movable between the first and second positions to move the fixing member between the fixing and release positions. The tab is disposed within the recess such that the tab is located below the surface of the housing in the first position.

### REFERENCE TO RELATED APPLICATION

This application claims the priority of United Kingdom Application No. 1716977.2, filed Oct. 16, 2017, the entire contents of which are incorporated herein by reference.

### FIELD OF THE INVENTION

The present invention relates to a filter assembly for a vacuum cleaner.

### BACKGROUND OF THE INVENTION

Vacuum cleaners generally comprise a main body which contains a motor-driven fan unit for drawing a dirt-bearing air flow into the vacuum cleaner, and separating apparatus such as a cyclonic separator or bag, for separating dirt and dust from the air flow. Whilst some separating apparatus provides efficient separation of dirt and dust from the air flow, vacuum cleaners are generally provided with filters pre- and/or post- the motor-driven fan unit to further remove dirt and dust from the airflow before it passes through the motor-driven fan unit and is exhausted from the main body.

Such filters are commonly removable from the vacuum cleaner to allow for cleaning and/or replacement of the filter.

### SUMMARY OF THE INVENTION

According to a first aspect of the present invention there is provided a filter assembly for a vacuum cleaner, the filter assembly comprising a housing, a filter medium disposed in the housing, a recess formed in a surface of the housing, a tab movable between a first position and a second position, and a fixing member movable between a fixing position and a release position, wherein the fixing member is engageable with the vacuum cleaner when in the fixing position so as to fix the filter assembly to the vacuum cleaner, the fixing member is disengageable from the vacuum cleaner when in the release position such that the filter assembly may be removed from the vacuum cleaner, movement of the tab between the first and second positions causes the fixing member to move between the fixing and release positions, and the tab is disposed within the recess such that the tab is located below the surface of the housing when in the first position.

The filter assembly according to the first aspect of the present invention may be beneficial principally as the filter assembly comprises a recess formed in a surface of the housing, a tab movable between a first position and a second position, and a fixing member movable between a fixing position and a release position, the fixing member is engageable with the vacuum cleaner when in the fixing position so as to fix the filter assembly to the vacuum cleaner, the fixing member is disengageable from the vacuum cleaner when in the release position such that the filter assembly may be removed from the vacuum cleaner, movement of the tab between the first and second positions causes the fixing member to move between the fixing and release positions, and the tab is disposed within the recess such that the tab is located below the surface of the housing when in the first position.

In particular, as the tab is disposed within the recess such that the tab is located below the surface of the housing in the first position, accidental movement of the tab from the first position to the second position, which would usually enable removal of the filter assembly from an operable position in a vacuum cleaner, may be inhibited. Furthermore, as the tab is located below the surface in the first position, and hence the tab does not normally project outwardly from the surface in an operable position, the surface of the filter assembly may form part of an external surface of a vacuum cleaner when it is in the operable position and/or may define a surface upon which other components of the vacuum cleaner may be mounted without affecting movement of the tab from the first position to the second position, which would usually enable removal of the filter assembly from an operable position in a vacuum cleaner. For example, the surface of the housing of the filter assembly may be substantially flush with a surface of a vacuum cleaner when the filter assembly is in an operable position in the vacuum cleaner.

The fixing member may fix the filter assembly in an operable position within the vacuum cleaner. By an operable position is meant a position in which the filter assembly is installed in the vacuum cleaner such that the filter assembly can perform its intended filtering function. The operable position may comprise a pre- and/or post-motor position.

The second position may comprise a position for enabling insertion/re-insertion of the filter assembly to an operable position within a vacuum cleaner.

The tab may be sub-flush with the surface of the housing of the filter assembly in the first position.

The recess may be formed in a surface of the housing which is exposed when the filter assembly is in its operable position. This may be beneficial as this may ensure that a user can access the tab to affect movement of the tab between the first and second positions. This may also be beneficial as the surface may define a component receiving surface of a vacuum cleaner when the filter assembly is in an operable condition, for example when the filter assembly is located in a corresponding recess of the vacuum cleaner, without risk of accidental movement of the tab between the first and second positions. The recess may be formed in an upper surface of the housing. The recess may be formed in a curved surface of the housing.

The fixing member may comprise a projection and/or recess for receiving a corresponding fixing recess and/or projection of a vacuum cleaner. The fixing member may comprise a projection extending outwardly from a surface of the housing, for example a surface other than the surface comprising the recess. The fixing member may be disposed on a surface of the housing of the filter assembly which is not exposed when the filter assembly is installed in a vacuum cleaner in an operable position. This may be beneficial as inadvertent movement of the fixing member between the fixing and release positions may be inhibited. The fixing member may extend outwardly from the housing in a direction substantially orthogonal to the surface comprising the recess. The fixing member and the corresponding fixing recess and/or projection may define a lock and key arrangement.

The fixing member may be connected to the tab, for example directly connected to the tab, and/or may be integrally formed with the tab. This may be beneficial as this may reduce the number of moving component parts of the filter assembly, thereby reducing the cost of manufacture, and/or ensuring reliable operation of the filter assembly as there a fewer moving component parts which may break in use.

The fixing member may extend outwardly through a channel formed in the housing, and may, for example, be movable within the channel between the fixing and release positions. This may be beneficial as the channel may constrain the motion of the fixing member, thereby ensuring reliable movement of the fixing member between the fixing and release positions.

The tab may be graspable by a user to affect movement between the first and second positions. The recess may be shaped and dimensioned to correspond to a finger and/or thumb of user. This may be beneficial as it may allow a user to easily access the tab when it is desired to grip the tab in use.

The tab may be pivotably mounted within the recess, and may, for example, be pivotable between the first and second positions. This may be beneficial as this may enable the recess to be relatively small, for example smaller than a recess required to accommodate sliding motion of the tab.

The tab may be resiliently biased toward the first position. This may be beneficial as this may further inhibit accidental activation of the tab to affect removal of the filter assembly from an operable position in a vacuum cleaner.

The tab may be disposed within the recess such that a gap is formed between the tab and a lower surface of the recess in the first position. This may be beneficial as the gap may allow a user to hook their thumb and/or finger underneath the tab to affect movement of the tab between the first and second positions. This may also increase the surface area of the tab that is available to be grasped by a user in the first position such that a user can obtain a more secure purchase on the tab when moving the tab between the first and second positions.

At least a portion of the tab may be located above the surface of the housing in the second position. This may be beneficial as this may increase the surface area of the tab that is available to be grasped by a user to hold the tab in the second position, for example during removal of the filter assembly from an operable position. At least a portion of the tab may pivot out of the recess when the tab is moved from the first position to the second position. This may be beneficial as the grip a user is able to obtain on the tab may increase as the tab is moved from the first position to the second position, as the surface area of the tab that is exposed to a user may increase between the first and second positions.

The filter assembly may comprise a further tab disposed within a further recess, and a further fixing member. The further tab may be movable between a first position and a second position. The further fixing member may be movable between a fixing position and a release position. The further tab may be movable between its first and second positions to move the further fixing member between its fixing and release positions. The further tab may be disposed within the further recess such that the further tab is located below the surface of the housing in the first position.

The tab and further tab may be movable toward one another between their respective first and second positions. This may be beneficial as this may enable the tabs to be moved and/or held by a pinching force, which may, for example, allow the tabs to be moved from the first positions to the second positions, and for the filter assembly to be removed from an operable position, without the need for a use to adjust their grip during removal. This may allow for smooth operation of the filter assembly during removal and/or re-insertion of the filter assembly from/to an operable position. The tab and further tab may locate to be graspable between a user's thumb and forefinger, for example using a pinching motion.

The filter assembly may be removable from an operable position when each of the tab and the further tab are in their respective second positions.

According to a second aspect of the present invention there is provided a vacuum cleaner comprising a main body and a filter assembly according to the first aspect of the present invention, wherein the main body comprises a filter assembly recess, the filter assembly is removably mounted within the filter assembly recess, the fixing member engages with the main body when in the fixing position so as to fix the filter assembly within the filter assembly recess, and the fixing member disengages from the main body when in the release position such that the filter assembly may be removed from the filter assembly recess.

The vacuum cleaner may comprise a separating apparatus removably mounted to the main body, and the separating apparatus may overlie the filter assembly when mounted to the main body. The separating apparatus may rest upon the surface of the housing of the filter assembly.

The filter assembly recess may be formed in a curved surface of the main body, and the surface of the housing of the filter assembly may be curved and conform to the curvature of the curved surface of the main body. The surface of the housing of the filter assembly may be substantially flush with a surface of the main body that surrounds the filter assembly recess. This may be beneficial as it may enable components, for example the separating apparatus of the vacuum cleaner, to be mounted easily upon the surface of the housing of the filter assembly and the surface of the main body that surrounds the filter assembly recess.

### BRIEF DESCRIPTION OF THE DRAWINGS

In order to better understand the present invention, and to show more clearly how the invention may be put into effect, the invention will now be described, by way of example, with reference to the following drawings:

FIG. 1 is a front upper perspective view of a filter assembly according to a first aspect of the present invention in a fixing configuration;

FIG. 2 is a front upper perspective view of the filter assembly of FIG. 1 in a removal configuration;

FIG. 3 is a front lower perspective view of the filter assembly of FIG. 2;

FIG. 4 is a front rear perspective view of the filter assembly of FIG. 1;

FIG. 5 is a side view of a disassembled vacuum cleaner according to a second aspect of the present invention;

FIG. 6 is a top plan view of a main body of the vacuum cleaner of FIG. 5 with the filter assembly removed;

FIG. 7 is an enlarged view of a filter assembly recess of the main body of FIG. 6; and

FIG. 8 is a top plan view of the main body of FIG. 6 with the filter assembly in an operable position.

### DETAILED DESCRIPTION OF THE INVENTION

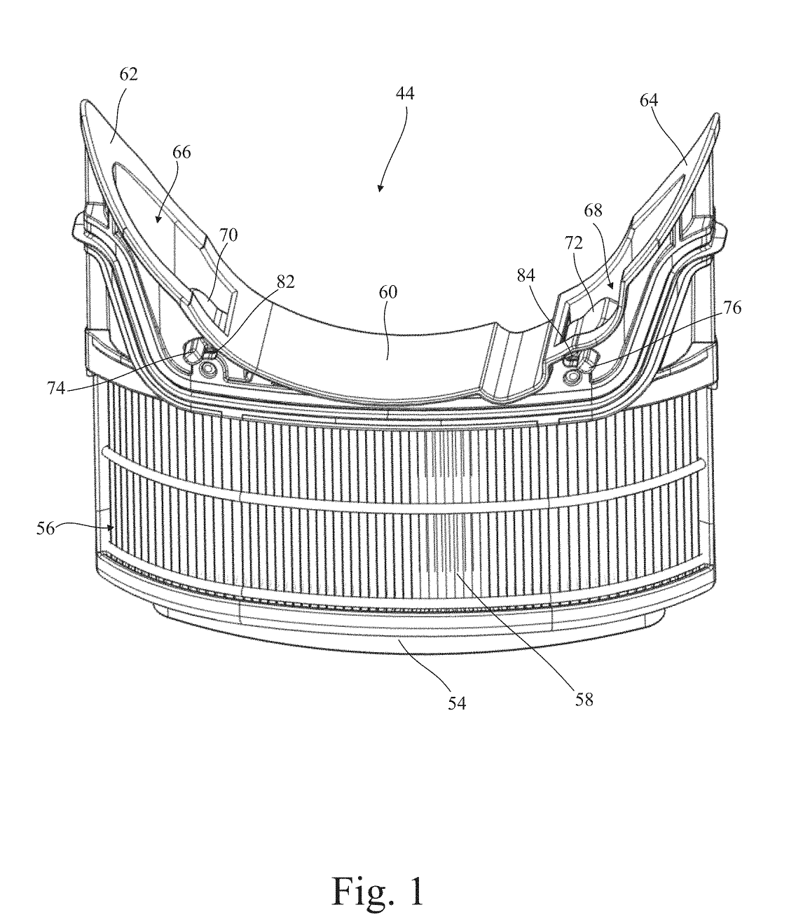

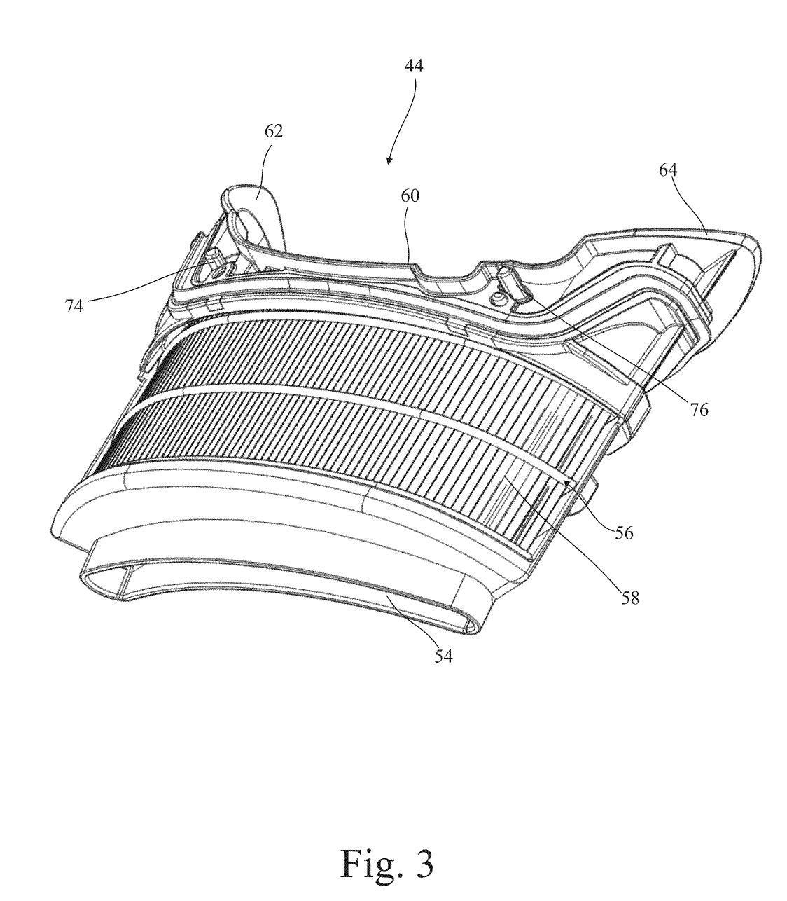

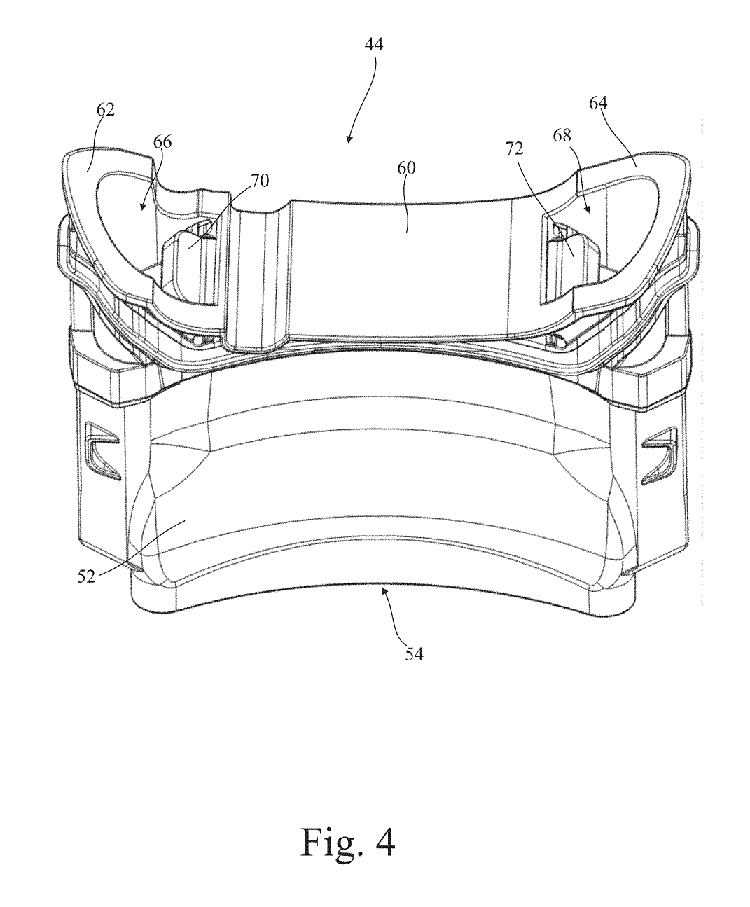

A filter assembly according to the present invention, generally designated 44, is shown in FIGS. 1-4.

The filter assembly 44 comprises a filter housing 52 having a filter inlet 54 and a filter outlet 56. The filter housing 52 is generally curved in form, and is substantially hollow. The filter inlet 54 comprises an aperture formed in a lower surface of the filter housing 52, and the aperture is in fluid communication with the interior of the filter housing 52. A wall of the filter housing 52 is substantially open to define the filter outlet 56, and the substantially open wall receives filter medium 58 such that the filter medium 58 defines channels within the interior of the filter housing 52. The filter outlet 56 has a larger surface area than the filter inlet 54, and hence may reduce noise in use.

An upper surface 60 of the filter housing 52 is curved and flared to form wings 62,64. The upper surface 60 comprises first 66 and second 68 recesses, within which are housed filter assembly removal tabs 70,72. By placing the filter assembly removal tabs 70,72 within the recesses 68,70, accidental activation of the tabs 70,72 may be avoided. The first 66 and second 68 recesses extend at least partially along the wings 62,64, and are shaped and dimensioned to correspond to a user's thumb and forefinger.

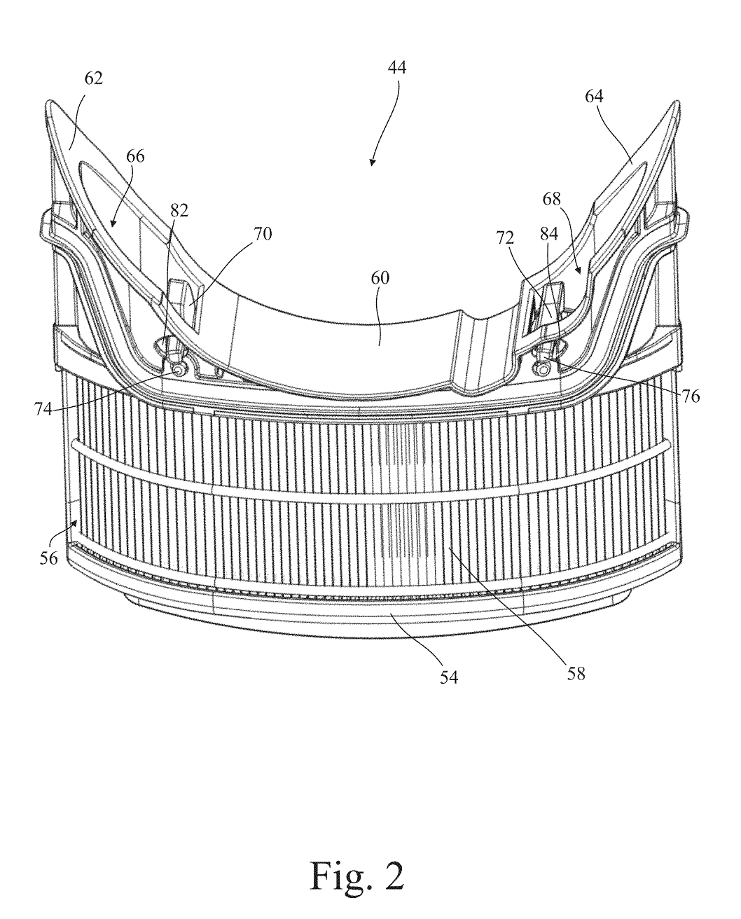

The filter assembly removal tabs 70,72 are generally planar, having curved end lips, and are pivotally mounted within the recesses 66,68 by front 74,76 and rear mounting pins. The front mounting pins 74,76 extend through respective channels 82,84 in the filter housing 52, and define locking formations 74,76 of the filter assembly 44. The filter assembly removal tabs 70,72 are pivotable between a locking position in which the tabs 70,72 are entirely housed within the recesses 66,68, and a removal/insertion position in which the tabs 70,72 extend partially out of the respective recesses 66,68. The locking position and removal/insertion position are shown respectively in FIGS. 1 and 2. The filter assembly removal tabs 70,72 are resiliently biased toward the locking position by appropriate biasing springs (not shown).

As can be seen from FIG. 1, when the tabs 70,72 are in the locking position, the front mounting pins 74,76 are disposed at first opposing ends of their respective channels 82,84. The tabs 70,72 are entirely housed within the recesses 66,68, and a gap exists between each tab 70,72 and the bottom of the respective recess 66,68. When it is desired to move the tabs 70,72 from the locking position to the removal/insertion position, a user may place their thumb and forefinger into respective recesses 66,68, and grip the tabs 70,72. By applying a pinching force to the tabs 70,72, ie by moving the tabs 70,72 toward one another against the action of the biasing springs, the front mounting pins 74,76 move toward one another within their channels 82,84, and the tabs 70,72 are pivoted such that the tabs 70,72 extend partially out of the recesses 66,68. The surface area of the tabs 70,72 that is available for a user to grasp may be increased as the tabs 70,72 are pivoted from the locking position to the removal/insertion position.

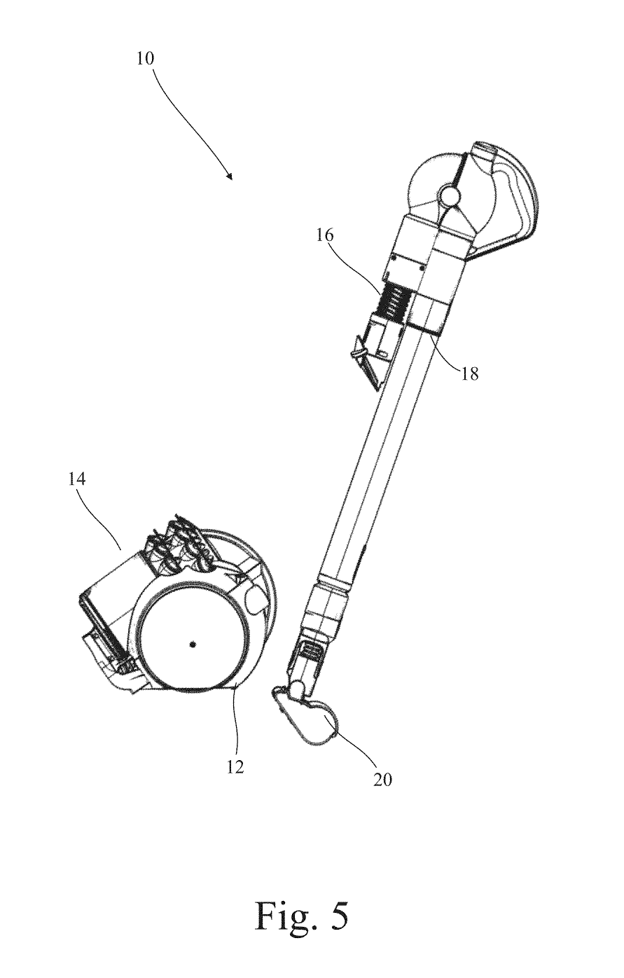

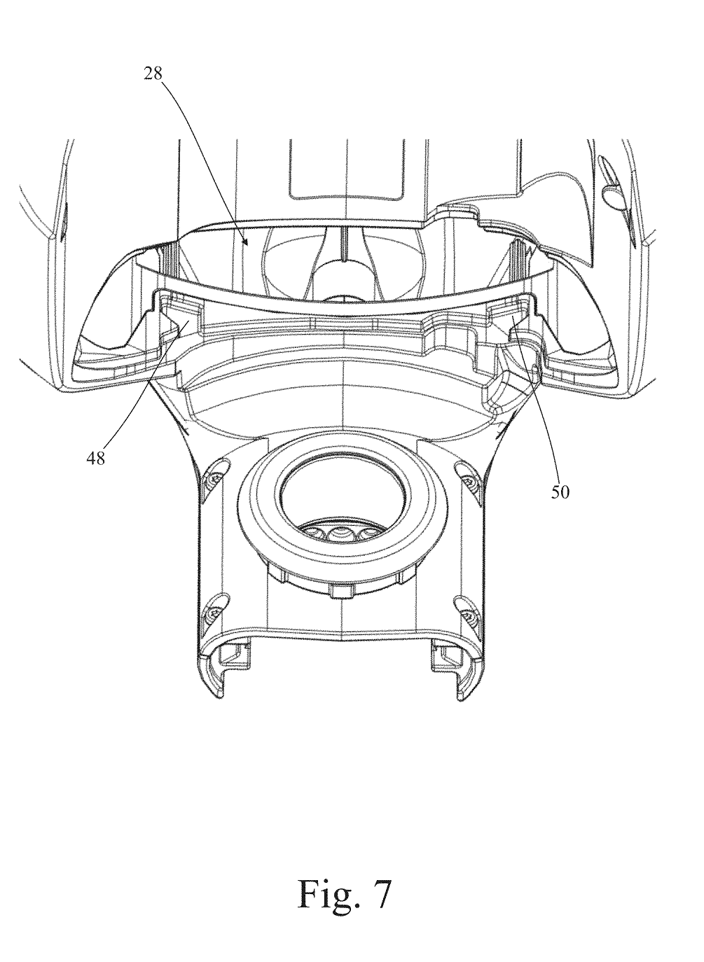

A vacuum cleaner, generally designated 10, utilising the filter assembly 44 of the present invention, is shown in FIGS. 5-8.

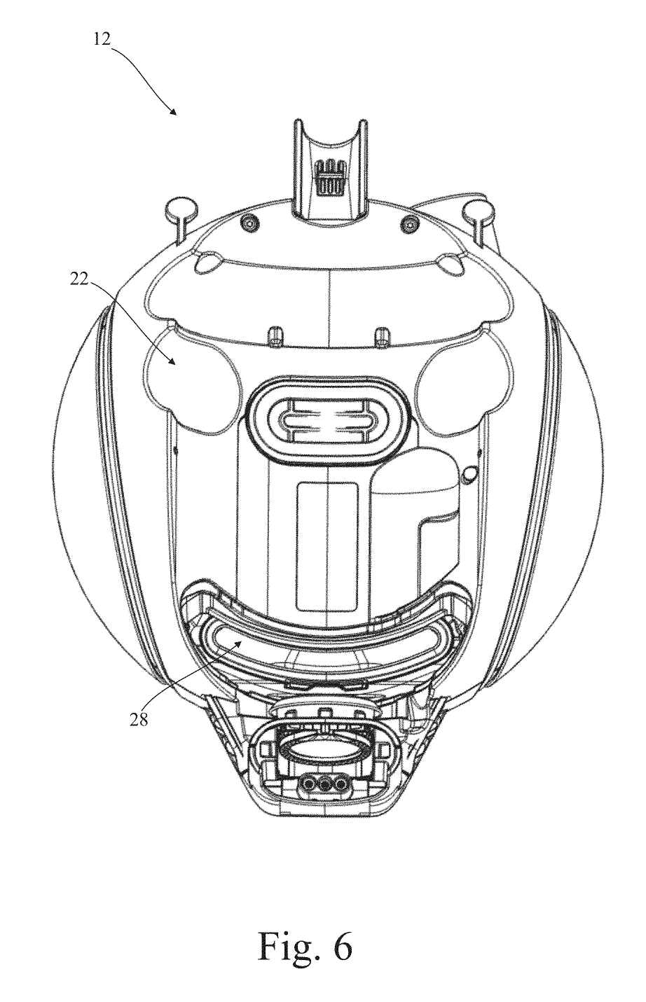

The vacuum cleaner 10 comprises a main body 12, a separating apparatus 14, a flexible hose 16, a wand assembly 18, and a cleaner head 20. The main body 12 is shown in isolation from the other components of the vacuum cleaner 10 in FIGS. 6-8. The separating apparatus 14, flexible hose 16, wand assembly 18, and cleaner head 20, are conventional, and so will not be described here in any detail, save to say that the separating apparatus 14 is a cyclonic separating apparatus having a dirty air inlet formed in a lower surface thereof, and also having a clean air outlet.

The main body 12 is generally spherical and hollow in form, and comprises a separator recess 22, and a filter assembly recess 28.

The separator recess 22 is shaped and dimensioned to receive the separating apparatus 14, such that a portion of the separating apparatus 14 protrudes upwardly from the separator recess 22.

The filter assembly recess 28 is formed in a curved surface of the separator recess 22. The filter assembly recess 28 is shaped and dimensioned to receive the filter assembly 44. An internal surface 46 of the main body 12 in the region of the filter assembly recess 28 comprises first 48 and second 50 locking formations for engaging corresponding locking formations 74,76 of the filter assembly 44. The first 48 and second 50 locking formations comprise substantially L-shaped recesses formed on the internal surface 46.

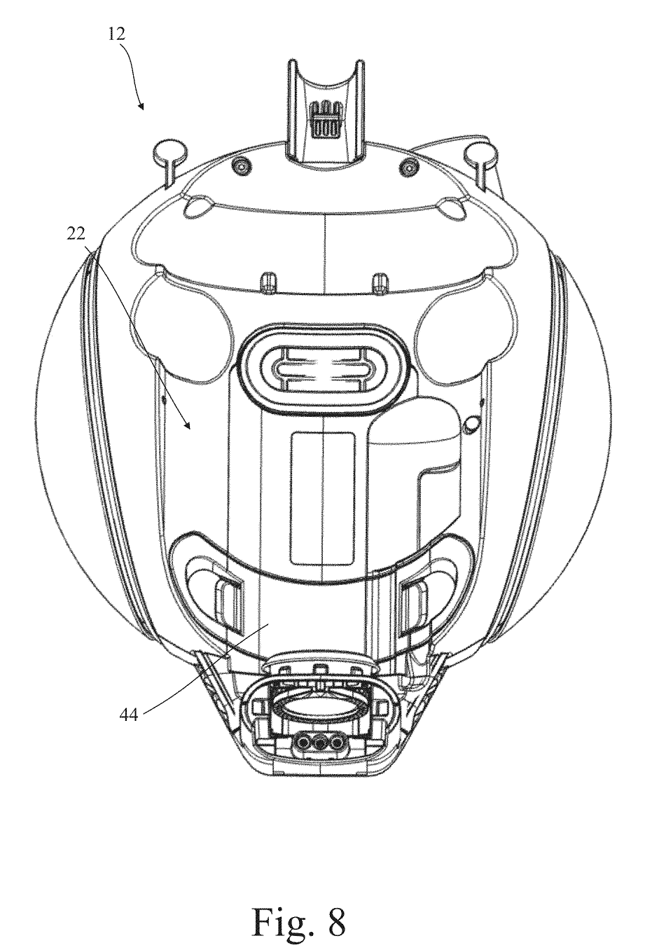

When the filter assembly 44 is inserted in the filter assembly recess 28 such that the filter assembly 44 is in an operable condition, for example as a post-motor filter, the filter inlet 54 is in fluid communication with exhaust air from a motor-driven fan unit mounted within the main body 12. The curvature of the upper surface 60 conforms to the curvature of the separator recess 22, such that the upper surface 60 of the filter housing 52 defines part of the surface of the separator recess 22, as seen in FIG. 8. Thus the separating apparatus 14 may partially rest upon the upper surface 60 of the filter assembly 44 in use.

The front mounting pins 74,76 engage corresponding portions of the first 48 and second 50 locking formations of the internal surface 46 of the main body 12 to prevent removal of the filter assembly from the filter assembly recess 28. When it is desired to remove the filter assembly 44, for example for cleaning and/or replacement, the tabs 70,72 are moved to the removal/insertion position as described above, and the front mounting pins 74,76 are aligned with channels of the L-shaped locking formations 48,50 such that the front mounting pins 74,76 can be removed from the corresponding locking formations 48,50, and the filter assembly 44 can be removed from the filter assembly recess 28.

In use, a motor-driven fan unit creates a suction flow through the vacuum cleaner 10. Air is drawn into the cleaner head 20, and passes through the wand assembly 18 and flexible hose 16 into the separating apparatus 14 via a dirty air inlet duct.

Dirt and dust is removed from the airflow by the separating apparatus 14, and clean air passes from the separating apparatus 14 to the motor-driven fan unit housed internally of the main body 12. Airflow exhausted by the motor-driven fan unit passes through the filter inlet 54 of the filter assembly 44, through the filter medium 58, and out of the filter outlet 56. Airflow from the filter outlet 56 is exhausted to ambient atmosphere via an outlet duct.

If it is desired to remove the filter assembly 44 for cleaning and/or replacement, then a user may use the filter assembly removal tabs 70,72 in the manner described above to enable removal and/or reinsertion of the filter assembly 44.

1. A filter assembly for a vacuum cleaner, the filter assembly comprising a housing, a filter medium disposed in the housing, a recess formed in a surface of the housing, a tab movable between a first position and a second position, and a fixing member movable between a fixing position and a release position, wherein the fixing member is engageable with the vacuum cleaner when in the fixing position so as to fix the filter assembly to the vacuum cleaner, the fixing member is disengageable from the vacuum cleaner when in the release position such that the filter assembly can be removed from the vacuum cleaner, movement of the tab between the first and second positions causes the fixing member to move between the fixing and release positions, and the tab is disposed within the recess such that the tab is located below the surface of the housing when in the first position.

2. The filter assembly of claim 1, wherein the fixing member is integrally formed with the tab.

3. The filter assembly of claim 1, wherein the fixing member extends outwardly through a channel formed in the housing.

4. The filter assembly of claim 1, wherein the fixing member is disposed on a surface of the housing which is not exposed when the filter assembly is located in an operable position in a vacuum cleaner

5. The filter assembly of claim 1, wherein the recess is shaped and dimensioned to correspond to at least a finger or a thumb of a user.

6. The filter assembly of claim 1, wherein the tab is pivotably mounted within the recess.

7. The filter assembly of claim 1, wherein the tab is resiliently biased toward the first position.

8. The filter assembly of claim 1, wherein the tab is disposed within the recess such that a gap is formed between the tab and a lower surface of the recess in the first position.

9. The filter assembly of claim 1, wherein at least a portion of the tab is located above the surface of the housing in the second position.

10. The filter assembly of claim 1, wherein at least a portion of the tab pivots out of the recess when the tab is moved from the first position to the second position.

11. The filter assembly of claim 1, wherein the filter assembly comprises a further tab disposed within a further recess, and a further fixing member, the further tab is movable between a first position and a second position, the further fixing member is movable between a fixing position and a release position, the further tab is movable between its first and second positions to move the further fixing member between its fixing and release positions, and the further tab is disposed within the further recess such that the further tab is located below the surface of the housing in the first position.

12. The filter assembly of claim 11, wherein the tab and the further tab are movable toward one another from their respective first positions to their respective second positions.

13. A vacuum cleaner comprising a main body and the filter assembly of claim 1, wherein the main body comprises a filter assembly recess, the filter assembly is removably mounted within the filter assembly recess, the fixing member engages with the main body when in the fixing position so as to fix the filter assembly within the filter assembly recess, and the fixing member disengages from the main body when in the release position such that the filter assembly can be removed from the filter assembly recess.

14. The vacuum cleaner of claim 13, wherein the vacuum cleaner comprises a separating apparatus removably mounted to the main body, and the separating apparatus overlies the filter assembly when mounted to the main body.

15. The vacuum cleaner of claim 14, wherein the separating apparatus rests upon the surface of the housing of the filter assembly.

16. The vacuum cleaner of claim 13, wherein the filter assembly recess is formed in a curved surface of the main body, and the surface of the housing of the filter assembly is curved and conforms to the curvature of the curved surface of the main body.

17. The vacuum cleaner of claim 13, wherein the surface of the housing of the filter assembly is flush with a surface of the main body that surrounds the filter assembly recess.
